(19) United States
(12) Patent Application Publication
(10) Pub. No.: US 2015/0287155 A1
(43) Pub. Date: Oct. 8, 2015

(54) Marketing Device

(71) Applicant: Vachik Stepanian, Glendale, CA (US)

(72) Inventor: Vachik Stepanian, Glendale, CA (US)

(21) Appl. No.: 14/243,831

(22) Filed: Apr. 2, 2014

(51) Int. Cl. G06Q 90/00

(52) U.S. Cl. CPC G06Q 90/00

(57) ABSTRACT

A marketing device that provides promotional or attention-grabbing signage, including but not limited to, flags, banners, balloons, electronic signs and/or flyers. The marketing device may comprise a ring and includes appendages on which attention-grabbing items may be mounted. The ring preferably fits on a post, pole, side of a house or other support structure. The flags or other attention-grabbing items may be mounted at an angle to draw increased attention. An optional lid may be mounted to the ring and may be customized with graphics.

### FIELD OF THE INVENTION

The present invention generally relates to marketing devices that may be used to promote real estate, cars or other items, and/or may be mounted on a post, pole, building, car or other support structures, and/or may support marketing signage, flags, banners or other marketing material.

### BACKGROUND OF THE INVENTION

Various types of real estate signposts exist and may include a horizontal arm or structure for mounting promotional signs. Most of these signposts may be erected in one manner only and do not accommodate different configurations of promotional displays. For example, in the real estate field, many existing marketing devices may only be located in an adjoining yard. Such devices are not reconfigurable for use in different locations, e.g., on a post or mounted on a building. Accordingly, there is a need for a marketing device that may be adapted for use in different locations and that may provide different types of promotional displays.

Certain existing real estate signposts are heavy, or are otherwise cumbersome to transport and erect, and are thus inconvenient to use. For example, certain existing real estate signposts require multiple posts or support structures to display signage. This adds complexity thereby increasing the time required to erect the signpost. Certain existing signposts are complicated in that they require numerous parts and increased expertise to assemble. This all leads to increased cost. Furthermore, certain existing signposts display their signage low to the ground, decreasing their effectiveness in attracting attention. Accordingly, there is a need for a marketing device that is readily portable, easy to erect and effective in attracting attention.

There are also various types of marketing devices used to promote other items such as cars and other vehicles. Oftentimes however, vehicles are marketed by banners placed on the windshield. Such banners do not stand above the vehicle and may not attract attention. Other marketing materials that are placed on the car's painted surfaces may scratch the vehicle's paint. Other marketing materials placed on a vehicle may blow off in the wind. Accordingly, there is a need for marketing devices that may attract attention by, e.g., standing above the vehicle. There is also a need for a marketing device that avoids damaging the car's surface and that securely remains on the vehicle.

### SUMMARY OF THE INVENTION

The current invention addresses the foregoing and other issues. In a first aspect of the invention, a marketing device is described that may be used to promote real estate, vehicles or other items. The marketing device is preferably adaptable for use with various items, and may include several mounting options so that it may be located and/or mounted in different positions. For example, the marketing device may be mounted to the top of a post, the side of a building, house and/or other structure, the top of a car or other locations to promote, draw attention to and/or display information.

In another aspect of the invention, the marketing device may include a variety of attention-grabbing items. For example, the marketing device may include promotional signage, flags, banners, balloons, electronic signs, flyers or other items. For example, in the case of real estate, the flags or other attention-grabbing items may be mounted at an angle to draw attention to the property to alert the public that the property is open for viewing and/or provide other detailed information about the property and/or the agent representing the owner of the property.

In another aspect of the invention, the marketing device may comprise a simple design that is easy to erect and easily portable. For example, the marketing device may comprise a mount that may be mounted at various locations such as on a post, on the side of a building, on the top of a vehicle or other location. The mount is preferably light. The marketing device may include an optional lid. The lid may be attached to the mount and may be customized with graphics, such as patriotic flags, or other promotional art for additional promotional and attention-grabbing value.

In another aspect of the invention, the marketing device reflects a design with relatively few parts so that the device is easy to manufacture and is relatively inexpensive.

In another aspect of the invention, the marketing device may be suited to mount on a car or other vehicle, or other metal or metallic surface. To this end, the mount may include a magnet or magnetized surface that may be attracted to the roof or other surface of a vehicle or other metallic surface. In this aspect of the invention, the surface of the mount which engages the metallic surface preferably avoids scratching or otherwise damaging the metallic surface.

### BRIEF DESCRIPTION OF THE DRAWINGS

FIG. 1 is a perspective view of a marketing device.

FIG. 2 is a top view of a marketing device.

FIG. 3 is a side view of a marketing device.

FIG. 4 is an opposite side view of a marketing device.

FIG. 5 is a perspective view of a lid.

FIG. 6 is a side view of the marketing device with a magnet feature.

FIG. 7 is a perspective view of another embodiment of a marketing device.

FIG. 8 is a top view of the embodiment of FIG. 7.

FIG. 9 is a side view of the embodiment of FIG. 7.

FIG. 10 is an opposite side view of the embodiment of FIG. 7.

### DETAILED DESCRIPTION OF THE PREFERRED EMBODIMENTS

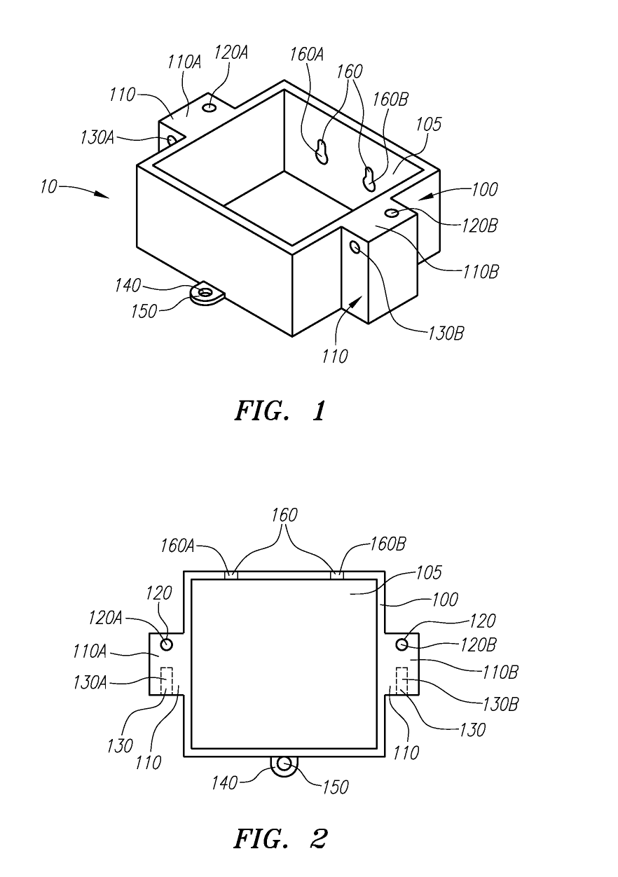

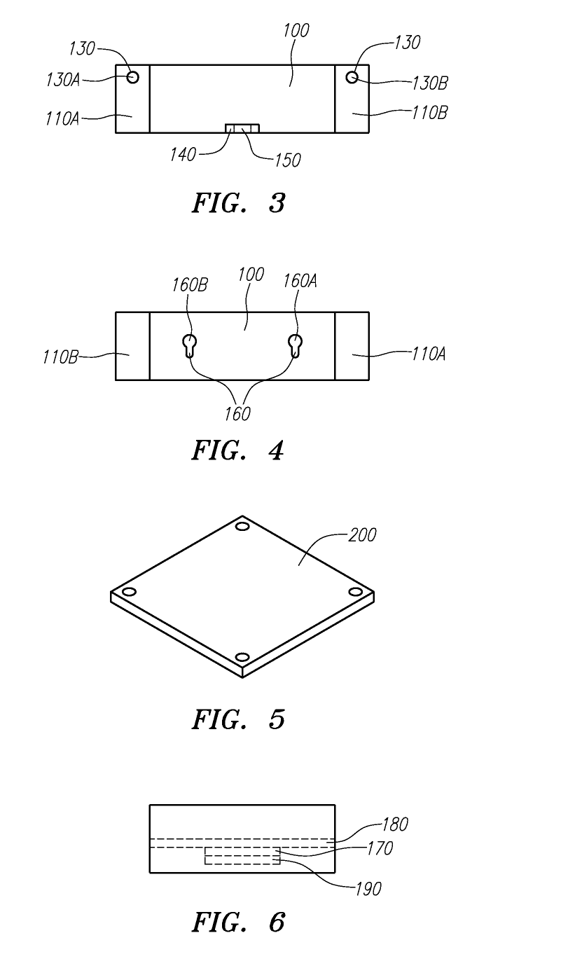

A first embodiment of the marketing device 10 of the current invention is now described with reference to FIGS. 1-10. FIG. 1 shows a perspective view of device 10 depicting its features. FIG. 2 shows a top view of device 10. FIG. 3 shows a side view of device 10, while FIG. 4 shows the opposite side view of device 10. FIG. 5 shows a perspective view of an optional lid 200. FIG. 6 shows a side view of device 10 with a magnet feature. Components appearing in more than one figure bear the same reference numerals.

As shown in FIG. 1, device 10 may include base or mount 100 that may in turn include ring 105 and appendages 110. Keyholes 160 may be formed in ring 105 to accommodate fasteners, such as screws, to attach device 10 to a post, to the side of a building or other structure or to other supporting items. Device 10 may also include tab 140 and tab hole 150 in which a fastener, such as a screw, may be used to attach device 10 to the side of a house or other structure. Device 10 may also include appendages 110 which may include holes 120, 130 for the purpose of providing a place for mounting flagpoles or other attention-grabbing items.

Ring 105 may generally be configured as a square and be dimensioned to allow device 10 to be mounted on a post that may in turn be driven into the ground or otherwise supported. In one embodiment, ring 105 may have interior dimensions that correspond to post sizes such as 4×4. However, other sizes may be used, and alternatively, ring 105 may comprise other shapes such as a rectangle, circle or other shapes. For example, a circular ring 105 may be preferred to mount to a support pole.

Device 10 may be mounted on a post, pole or other support made of wood, plastic, or other material having dimensions that allow device 10 to fit over it. The interior dimensions of ring 105 may be the same as the exterior dimensions of the post, pole or other support, or slightly larger in order to allow device 10 to slide thereover.

The interior dimensions of ring 105 may be such that device 10 fits snugly enough on the post, pole or other support to render fasteners, such as screws, unnecessary. However, the interior dimensions of ring 105 may be larger than its corresponding support to more easily fit thereon. Fasteners, such as screws, may then be used to secure device 10 to the support.

Alternatively, ring 105 may include an inward facing lip at or near its top edge. In this embodiment, after ring 105 is placed on the post, pole or other support structure, the lip may engage the top of the support structure so that device 10 may be suspended thereby. As noted above, fasteners may also be used to more securely attach device 10 to the support structure.

Base or mount 100 may include appendages 110. As shown, appendages 110 may extend outward at opposite sides of ring 105. Alternatively, fewer or more appendages 110 may be attached to ring 105.

Appendages 110 preferably include holes, slits or mounting locations 120, 130 in which attention-grabbing items may be inserted or otherwise attached. For example, appendage holes 120, 130 may be sized to accommodate the diameter of flagpoles that may support attention-grabbing flags. In this example, the sizing of appendage holes 120, 130 may be such that the flagpoles would fit snugly in order for them to stay in place. The inside diameter of these appendage holes 120, 130 may vary to accommodate flagpoles or other promotional items of different diameters or cross-sections.

In an alternative design, appendages 110 may include other types of mounts to accommodate attention-grabbing items besides flagpoles for flags. For example, knobs (not shown) may be used which may be grasped by clamping mechanisms that may in turn support marketing materials.

Where appendage holes 120, 130 are used, their depth may not extend all the way through appendages 110, thereby creating a bottom to the appendage holes 120, 130 to provide a snug and secure fit for the flagpoles or other attention-grabbing item. A press fit may exist between the flagpole and holes 120, 130. As the flagpoles are inserted into appendage holes 120, 130 and normally remain there due to the press fit exerting reasonable gripping force, this press fit also allows quick and convenient removal and replacement of the current flagpoles with a different set of flagpoles.

Appendage holes or mounts 120, 130 may be oriented at an angle from a vertical perspective and from each other. These angles may be in the range of 30 to 45 degrees, but other angles may be used. Appendage holes 120, 130 may also be vertical or horizontal. This angled orientation preferably increases the attention-grabbing visibility of the flags, banners or other promotional item inserted therein or otherwise attached thereto, and the possible promotional messages printed upon them.

Appendage holes or mounts 120, 130 preferably grip the flagpoles or other promotional item in a sturdy enough fashion along with device 10 being affixed to the support structure to withstand the typical wind forces that may be encountered. In this manner, the promotional material used with device 10 may continue to fulfill its marketing function.

Keyholes 160 may be sized to accept fasteners, such as screws, in order to attach device 10 to a post, pole, side of a building or other structure. The larger portion of keyholes 160 preferably fit over the head of a fastener and then as device 10 is slid or pressed downward, the upper slot feature of keyholes 160 may surround the shaft of the fasteners. The fasteners may then be tightened to secure device 100 to the post, pole or other support structure, or need not be.

Tab hole 150, extending through tab 140, may be sized to accept fasteners such as screws or bolts in order for device 10 to be attached to a house or side of a building. When device 10 is attached to the support structure with hole 140 and tab 150, the direction of appendage holes or mounts 120, 130 may be varied. That is, ring 105 may extend horizontally as opposed to the vertical configuration shown in FIG. 1. In this manner, device 10 provides different configurations for mounting and display of the flags or other promotional items.

Optional lid 200 in FIG. 5 may attach to ring 105, and may comprise varying materials such as plastic, wood or metal. Lid 200 may have art or a message inscribed on it to support the promotional mission of device 10. Lid 200 may also serve as a base upon which to attach static signage, electronic signage or a box for advertisement flyers, again to support the promotional mission of device 10.

Optional lid 200 may vary in size, whether it be approximately the same size as ring 105 or larger in order to feature more room for applying a promotional message. Also, lid 200 may vary in shape in order to meet the requirements of the inscribed promotional message such as a square shape or perhaps a rectangular shape. Lid 200 may also be configured in different sizes and shapes to correspond to ring 105.

Optional lid 200 may be attached to ring 105 with fasteners, such as screws, that may be driven through lid holes 210 into the top edges of ring 105. Where device 10 is intended to have lid 200, ring 105 may include holes drilled into its top edges in the same configuration of lid holes 210.

Optional lid 200 may also be attached to the top edges of ring 105 through the use of snaps or other types of fasteners. One half of the snap fasteners may be affixed to the underside of optional lid 200, while the corresponding other half of the snap fasteners may be affixed to the top edges of ring 105. These snap fasteners may allow an optional lid 200 to be changed out by the operator to a different one, with a different promotional message or artwork, without the need for any tools to accomplish this task.

Optional lid 200 may also be attached to the top edges of ring 105 through the use of Velcro-type fasteners. One half of the Velcro-type fasteners may be affixed, e.g., glued, to the underside of optional lid 200, while the corresponding other half of the Velcro-type fasteners would be affixed, e.g., glued, to the top edges of ring 105. These Velcro-type fasteners may allow an optional lid 200 to be changed out by the operator to a different one, with a different promotional message or artwork, without the need for any tools to accomplish this task. This method of attachment may also render unnecessary that holes be drilled through optional lid 200 and the top edges of ring 105.

The color of device 10 may vary to match or complement the color of the real estate post, the house, the supported signage or the flags, the vehicle or other item being marketed, in order to present a pleasing and professional appearance and to grab attention.

Ring 105 and lid 200 may comprise various materials such as metal, plastic, wood or other suitable material. It is preferred that the material chosen may readily have holes drilled into it as necessary, and/or may facilitate manufacture. To this end, ring 105 may be formed by extrusion. Alternatively, ring 105 may comprise sides or sections joined together.

Another embodiment involving a magnet to hold device 10 in place on a metal or metallic surface is now described with reference to FIG. 6. As shown, magnet 170 may be held in place by magnet support 180 within the interior of ring 105 and positioned approximately upward from the bottom of ring 105. Magnetic support may comprise a flange to which the magnet is attached. Alternatively, the bottom surface of magnet 170 may be flush with the bottom of ring 105. Alternatively, magnet 170 may be glued or otherwise attached to the interior of ring 105 without any magnet support 180.

In this configuration, device 10 may be attached to the roof of a vehicle or other metal surface. As discussed above, signage or flags may be attached to device 10 for promotional purposes. The size of the magnet may vary to provide the desired magnetic strength to firmly affix device 10 to the metallic surface. In some cases, it may be desired to secure device 10 in place while the car on which it is mounted moves. In this situation device 10 preferably provides a marketing function for the moving vehicle.

As shown in FIG. 6, a cushioning material 190 may be located between magnet 170 and the metal surface. Cushioning material 190 may be made of various materials such as cloth, leather or foam plastic. Cushioning material 190 may prevent damage to the metal surface that could occur if magnet 170 rested directly on the roof of the vehicle. A cushioning material may also be mounted to the bottom surface of ring 105.

When device 10 is equipped with magnet 170, it may also be mounted to a steel-sided building or wall through magnetism rather than drilling holes into the building to accommodate fasteners such screws or nails. This type of magnetic mounting preferably avoids the damage associated with screws or nails.

When device 10 is equipped with magnet 170, it may also be mounted upon a steel filing cabinet or other type of steel cabinet for promotional purposes. Being that the attachment method is magnetic, it is temporary and may be removed as required.

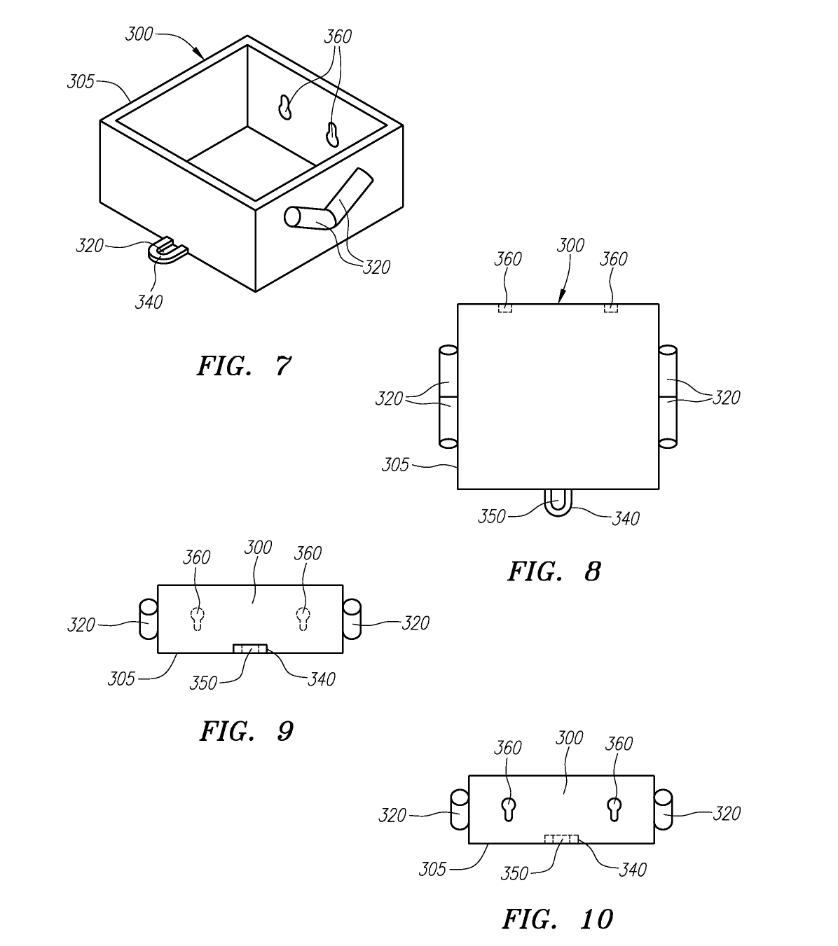

Another embodiment of marketing device 300 is shown in FIGS. 7-10. FIG. 7 shows a perspective view of the device. FIG. 8 shows a top view of the device. FIG. 9 shows a side view of the device. FIG. 10 shows an opposite side view of device 300.

As shown in FIG. 7, device 300 may include ring 305 which includes keyholes 360 to accommodate fasteners, such as screws, to attach device 300 firmly to a support structure. Device 300 may also include tab 340 and tab hole 350 in which a fastener, such as a screw, may attach device 300 to the side of a house or other structure. Device 300 may also include mounting tubes or knobs 320 in order to provide a place for mounting flagpoles or other marketing items. Alternatively, clamping mechanisms may attach to the exterior of tubes 320. To this end, tubes 320 may be square or some other shape.

Mounting tubes or knobs 320 may be attached to device 300 through welding or a variety of fasteners. Alternatively, mounts 320 may be contiguously formed with ring 305. Mounting tubes 320 may be positioned at an angle upon device 300 so as to allow the mounting of flags upon flagpoles or other marketing materials at an angle, thereby increasing attention-getting effects.

Mounting tubes 320 may be attached to ring 305 and device 300 through a swivel device rather than rigidly in one position. This may allow the operator to vary the angle at which the mounting tubes or mounts 320 are positioned, thereby changing the position and appearance of the flags or other promotional items attached thereto.

Although certain presently preferred embodiments of the invention have been described herein, it will be apparent to those skilled in the art to which the invention pertains that variations and modifications of the described embodiments may be made without departing from the spirit and scope of the invention.

What is claimed is:

1. A marketing device comprising:
a base that is configured to mount to a support structure; and
at least one mount attached to the base to support promotional materials.

2. The marketing device of claim 1, further comprising a lid attached to the base.

3. The marketing device of claim 1, wherein the base comprises a ring.

4. The marketing device of claim 3, further comprising at least one appendage mounted to the ring, wherein the at least one mount is located on the at least one appendage.

5. The marketing device of claim 4, further comprising a flagpole mounted to the mount.
